(19) United States
(12) Patent Application Publication
(10) Pub. No.: US 2013/0042629 A1
(43) Pub. Date: Feb. 21, 2013

(54) TURBOMACHINE LOAD MANAGEMENT ASSEMBLY

(71) Applicants: David T. Feindel, Ellington, CT (US); Paul W. Palmer, S. Glastonbury, CT (US); Jonathan P. Burt, Sturbridge, MA (US); Raymond N. Frick, S. Glastonbury, CT (US)

(72) Inventors: David T. Feindel, Ellington, CT (US); Paul W. Palmer, S. Glastonbury, CT (US); Jonathan P. Burt, Sturbridge, MA (US); Raymond N. Frick, S. Glastonbury, CT (US)

(21) Appl. No.: 13/211,677

(22) Filed: Aug. 17, 2011

(51) Int. Cl. F02C 7/20; B23P 15/04

(52) U.S. Cl. 60/796; 29/889.22

(57) ABSTRACT

An example turbomachine load management assembly includes a support rod extending from a first rod end to a second rod end that is moveable radially relative to a fan duct, a bearing housing, or both, when the support rod is coupling the fan duct and the bearing housing.

### BACKGROUND

This disclosure relates generally to managing loads and, more particularly, to managing loads within turbomachines.

Turbomachines include multiple sections, such as a fan section, a compressor section, a combustor section, and a turbine section. Air moves into the turbomachine through the fan section. Airfoil arrays in the compressor section rotate to compress the air, which is then mixed with fuel and combusted in the combustor section. The products of combustion are expanded to rotatably drive airfoil arrays in the turbine section through a shaft. Rotating the airfoil arrays in the turbine section drives rotation of the fan and compressor sections. Gas turbine engines are one example turbomachine.

Supporting components of turbomachines is often difficult. Supports face extreme temperatures and extreme loads, such as blade out events.

### SUMMARY

An example turbomachine load management assembly includes a support rod extending from a first rod end to a second rod end. The support rod is moveable radially relative to a fan duct, a bearing housing, or both, when the support rod is coupling the fan duct and the bearing housing.

An example supported turbomachine assembly includes a fan duct establishing an axis, and a bearing housing coaxially aligned with the fan duct. A support arrangement couples the fan duct to the bearing housing. The support arrangement includes support rods distributed circumferentially about the axis. The support rods are each moveable radially relative to the fan duct, the bearing housing, or both.

An example turbomachine support method includes coupling a radially inner end of a support rod to a bearing housing and coupling a radially outer end of the support rod to a fan duct. The method includes moving the support rod radially to decouple the radially inner end, the radially outer end, or both during, for example, the unbalanced loading experienced during a blade-out event.

### DESCRIPTION OF THE FIGURES

The various features and advantages of the disclosed examples will become apparent to those skilled in the art from the detailed description. The figures that accompany the detailed description can be briefly described as follows:

FIG. 1 shows a highly schematic view of an example gas turbine engine.

FIG. 2 shows a section view at line 2-2 in FIG. 1 showing an example supporting arrangements.

FIG. 3 shows a close-up view of an end of a seated support rod within the FIG. 2 supporting arrangement.

FIG. 4 shows a close-up view of an end of an unseated support rod within the FIG. 2 supporting arrangement.

FIG. 5 shows a close-up view of an end of another example seated support rod.

### DETAILED DESCRIPTION

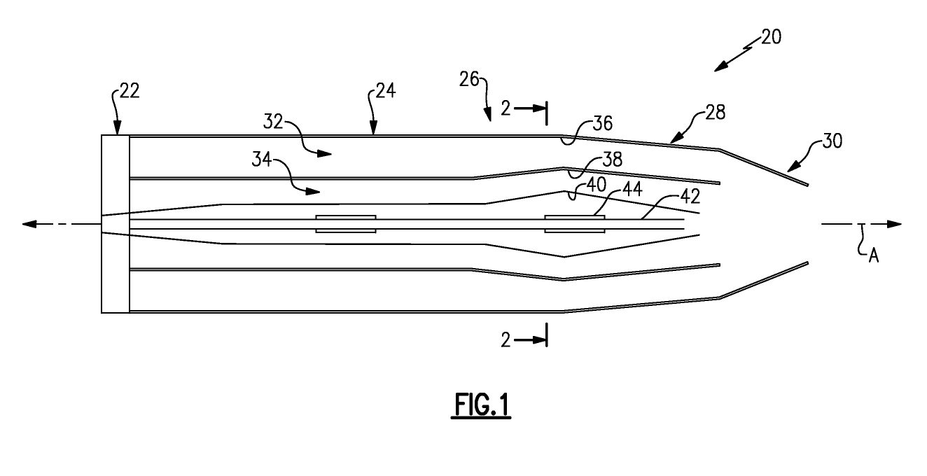

FIG. 1 schematically illustrates a gas turbine engine 20, which is an example type of turbomachine. The gas turbine engine 20 is disclosed herein as a two-spool turbofan that generally incorporates a fan section 22, a compressor section 24, a combustor section 26, a turbine section 28 and a nozzle section 30.

The fan section 22 moves air into the engine 20. The air moves along a bypass flow path 32 or a core engine flow path 34. A fan duct 36 establishes the radially outer boundary of the bypass flow path 32. The fan duct 36 also establishes the loadpath that maintains concentricity between the core flow 34, the bypass flow 36, and the shaft 42. The fan duct 36 reacts to the axial and torsional load from the fan section 22, the nozzle section 30, and additional aerodynamic or maneuver loads from the core 34 to the bypass 32.

A core engine duct 38 establishes the radially inner boundary of the bypass flow path 32. The core engine duct 38 also establishes the radially outer boundary of the core engine flow path 34. An inner case 40 establishes the radially inner boundary of the core engine flow path 34.

Air moving along the core flow path is compressed in the compressor section 24. The compressed air is mixed with fuel and combusted in the combustor section 26. The products of the combustion are then expanded within the turbine section 28 to rotate a shaft assembly 42.

The shaft assembly 42 generally includes a low-speed spool and a high-speed spool mounted for rotation about an engine central longitudinal axis A via several bearing systems.

A bearing housing 44 supports one of the bearing systems that rotatably supports the shaft assembly 42. Other bearing housings may support other bearing systems elsewhere in the engine 10. Notably, neither the bypass flow path 32 nor the core engine flow path 34 extends into the bearing housing 44. Also, the fan duct 36 and the bearing housing 44 do not establish any portion of the core engine flow path 34 or any portion of the bypass flow path 32.

Although the examples in this disclosure are disclosed with reference to the gas turbine engine 20, it should be understood that the concepts described herein are not limited to use with such a gas turbine engine. That is, the teachings of this disclosure may be applied to other types of turbine engines and other types of turbomachines.

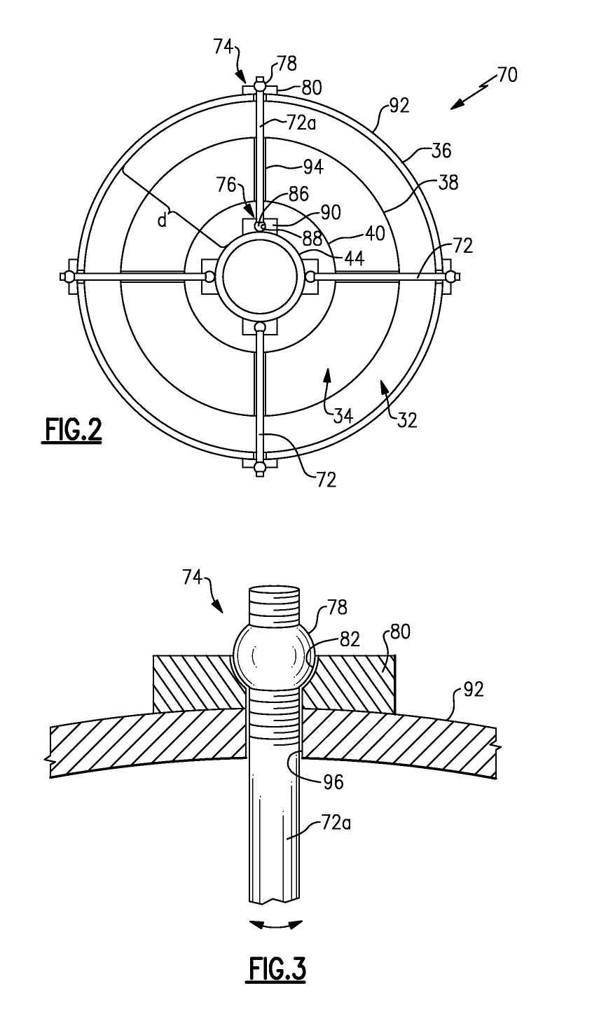

Referring to FIGS. 2-4 with continuing reference to FIG. 1, an example supporting arrangement 70 couples the fan duct 36 with the bearing housing 44. The supporting arrangement 70 includes a plurality of support rod assemblies 72 distributed circumferentially about the axis A and extending radially between the fan duct 36 and the bearing housing 44. The example supporting arrangement 70 includes four of the support rods 72. Other examples may include other numbers of the support rods 72. In this example, the support rod 72a is representative of all the support rods 72 within the supporting arrangement 70.

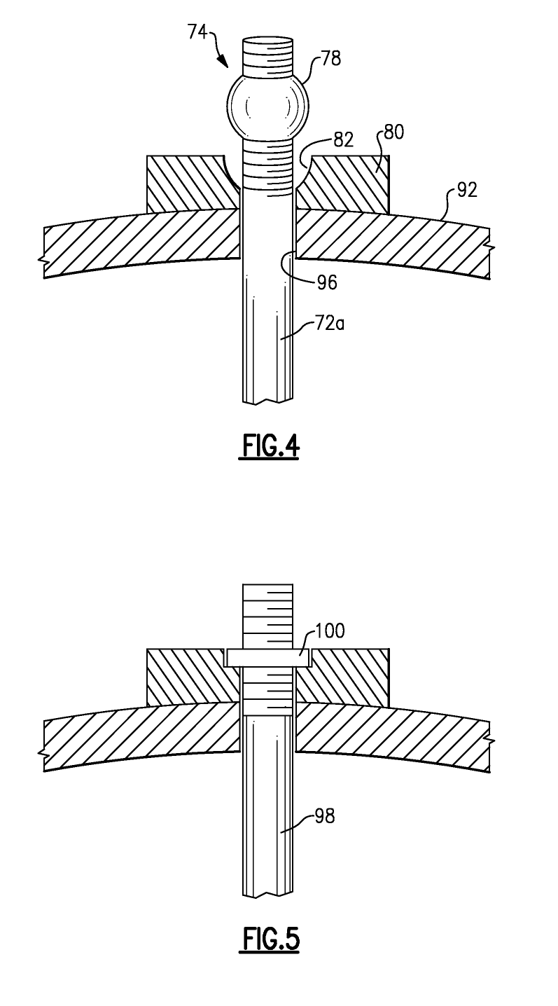

The support rod 72a extends from a first rod end 74 to a second rod end 76. In this example, the first rod end 74 is a radially outer rod end, and the second rod end 76 is a radially inner rod end. The first rod end 74 includes a head 78 that is moveable between a seated position (FIG. 3) and an unseated position (FIG. 4) relative to a support 80. The example head 78 is received within a socket 82 of the support 80 when the head 78 is in the seated position. The head 78 is displaced from the socket 82 of the support 80 when the head is in the unseated position. The head 78 is a portion of the support rod 72.

The second rod end 76 includes a head 86 that is received within a socket 88 of a support 90. The head 86 and support 90 are designed such that the head 86 remains seated within the support 90 when the support rod 72a is coupling the fan duct 36 with the bearing housing 44. Other examples may include the head 86 being moveable to an unseated position relative to the support 90 instead of, or in addition to, the head 78 being moveable to an unseated position relative to the support 80.

The example support 80 is a fan duct support that is secured directly to a radially outwardly facing surface 92 of the fan duct 36. The socket 82 established in the support 80 allows the support rod 72a to rotate about the first rod end 74 back and forth while the head 78 is in the seated position. Allowing this rotation accommodates some movements of the fan duct 36 relative to the bearing housing 44, such as relative movement associated with relative thermal growth or axial pressure loading between the two components. The range of rotation of the support rod 72a is typically about 1-2 degrees.

Although the example support 80 is described as being a structure separate from the fan duct 36, the fan duct 36, in another example, may form a portion of the support 80. For instance, the socket 82 may be formed in the walls of fan duct 36.

The example support 90 is a bearing housing support that is secured directly to an outwardly facing surface of the bearing housing 44. The socket 88 established in the support 90 allows some rotation of the support rod 72a about the second rod end 76. The bearing housing 44 may form a portion of the example support 90, rather than the support being a structure that is separate from the bearing housing 44.

When the head 78 is seated within the socket 82 and the head 86 is seated within the socket 88, the radial distance between circumferentially aligned portions of the fan duct 36 and the bearing housing 44 is a distance d. The example support rod 72a is considered to couple the fan duct 36 and the bearing housing 44 because the support rod 72a prevents a radial distance between the fan duct 36 and the bearing housing 44 from increasing more than the distance d such that the fan duct 36 is separated from the bearing housing 44.

Notably, because the head 78 is moveable to an unseated position (where the head 78 is radially spaced from the socket 82) the fan duct 36 and the bearing housing 44 are able to move closer than the distance d while still being coupled by the support rod 72a. The support rod 72a thus provides a flexible connection that couples the fan duct 36 and the bearing housing 44 without rigidly fixing the distance between the two components.

The first rod end 74 of the support rod 72a extends through an aperture 96 established in the fan duct 36. The diameter of the aperture 96 is large enough to accommodate the 1-2 degree rotations of the support rod 72a about the first rod end 74.

The support rod 72a also extends through apertures in the core engine duct 38 and the inner case 40. The support rod 72a may extend through a strut 94 that connects the core engine duct 38 and the inner case 40.

The support arrangement 70 supports the bearing housing 44 and the fan duct 36 during normal operation and during many abnormal operations. In one example abnormal operation, a blade-out event within the engine 20 cause a portion of the bearing housing 44 to move radially outward toward the fan duct 36. The support rod 72a is able to accommodate this movement without the bearing housing 44 becoming uncoupled from the fan duct because the head 78 of the support rod 72a is able to move away from the support 80 to an unseated position.

During normal operations of the engine 20, the support rod 72a is loaded such that the head 78 remains in the seated position. In this example, a relatively high preload is applied to support rod 72a to keep the head 78 from unseating during normal operation. The example head 78 only becomes unseated at the very high loads associated with unbalanced loading experienced during a blade-out event.

The loading due to a blade-out event is typically a load concentrated on the bearing housing 44. The concentrated load rotates about the axis A as the shaft assembly 42 rotates. The supporting arrangement 70 accommodates the rotating loads associated with the blade-out event by moving the support rod 72a circumferentially closest to the load from the seated position to the unseated position. The particular support rod 72 of the supporting arrangement 70 that is unseated moves circumferentially around the axis A with the load. One or more of the support rods 72 may become unseated at the same time.

The thickness and materials of the support rod 72 is determined based on the tensile strength of the support rod 72. The tensile strength reflects the ability of the support rod 72 to continue to couple the bearing housing 44 with the fan duct 36 even during a blade-out event, for example.

Unseating the head 78 forces the loads associated with the blade-out event to be carried by other support rods 72 of the supporting arrangement 70 and other structures. The loads associated with the blade-out event are forced to follow a longer load path having a non-linear step change. Compared to the rigid attachments of the prior art, the supporting arrangement 70 has a lower core support spring rate. Lowering the support spring rate lowers the maximum transmitted dynamic load as more of the unbalanced load is absorbed into the flexing core cases. During lower loads of normal unbalance (no blade loss) and aircraft maneuvers, the pre-loading on the supporting rods 72 keeps the heads 78 seated and the system spring rate remains linear.

In this example, the support rod 72a includes a threaded rod, and the heads 78 and 86 are bored and threaded spheres that are screwed on to the threaded rod.

Although the example head 78 moves relative to the fan duct 36 in a radially outward direction when moving from the seated position to the unseated position, another example head may move radially inward. That is, other examples of the support rods 72 may include heads that move relative to the bearing housing 44 or the fan duct in a radially inward direction.

Further, although the example heads 78 and 86 are spherical, another example support rod 98 may include one or more heads 100 (FIG. 5) that are a flat plate or some other type of structure.

Features of the disclosed examples include a supporting arrangement that more effectively distributes loads than prior art designs, especially loads associated with blade-out events. Thus, lower yield capability materials and relatively thin supporting rods can be used within a supporting arrangement. The supporting arrangement does not plastically deform during a blade-out event.

Another feature of the disclosed examples is to distribute loads associated with a blade-out event to travel along a longer load path than prior art rigid supports. Unseating the support rod lowers the support structure spring rate in a non-linear step change, and lowers the maximum transmitted dynamic load as more of the unbalanced load is absorbed into other areas of the engine. The nonlinear step reduction in the lower core support spring rate reduces the dynamic transmissibility of the load through the nearby structures (e.g., the bearing support 44) and the support rods 72. Lighter structures can thus be used.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

We claim:

1. A turbomachine load management assembly, comprising:
a support rod extending from a first rod end to a second rod end, wherein the support rod is moveable radially relative to a fan duct, a bearing housing, or both, when the support rod is coupling the fan duct and the bearing housing.

2. The turbomachine load management assembly of claim 1, wherein the support rod is moveable radially between a seated position and an unseated position when coupling the fan duct and the bearing housing, the support rod including a head that is received within a socket of a support when the support rod is in the seated position, and is displaced from the socket of the support when the support rod is in the unseated position.

3. The turbomachine load management assembly of claim 2, wherein the support is a fan duct support attached directly to an outwardly facing surface of the fan duct.

4. The turbomachine load management assembly of claim 2, wherein the support is a bearing housing support attached directly to an outwardly facing surface of the bearing housing.

5. The turbomachine load management assembly of claim 2, wherein the support rod is rotatable relative to the support about the head when the support rod is in the seated position.

6. The turbomachine load management assembly of claim 2, wherein the support rod couples the fan duct and the bearing housing when the support rod is in the seated position and when the support rod is in the unseated position.

7. The turbomachine load management assembly of claim 1, wherein the first rod end includes a first head that is received within a fan duct socket when the fan duct is spaced a first radial distance from the bearing housing, and the second rod end includes a second head that is received within a bearing housing socket when the fan duct is spaced the first radial distance from the bearing housing, wherein the first head, the second head, or both, are displaced from the fan duct socket or the bearing housing socket when the fan duct is spaced a second radial distance from the bearing housing, the second radial distance less than the first radial distance.

8. The turbomachine load management assembly of claim 1, wherein the support rod comprises a threaded rod.

9. The turbomachine load management assembly of claim 1, wherein the support rod is configured to extend through an aperture established in the fan duct.

10. The turbomachine load management assembly of claim 1, wherein the support rod is securing the fan duct relative to the bearing housing when coupling the fan duct to the bearing housing.

11. A supported turbomachine assembly, comprising:
a fan duct extending along an axis;
a bearing housing coaxially aligned with the fan duct; and
a supporting arrangement coupling the fan duct with the bearing housing, the supporting arrangement including a plurality of support rods distributed circumferentially about the axis, wherein each of the plurality of support rods is moveable radially relative to the fan duct, the bearing housing, or both, while coupling the fan duct to the bearing housing.

12. The supported turbomachine assembly of claim 11, wherein each of the plurality of support rods have a radially outer end and a radially inner end, the radially outer end held within a socket of a fan duct support structure, and the radially inner end held within a socket of a bearing support structure.

13. The supported turbomachine assembly of claim 11, wherein each of the plurality of support rods extends radially through a respective aperture established by the fan duct.

14. The supported turbomachine assembly of claim 11, wherein each of the plurality of support rods have a radially outer end and a radially inner end, the radially outer end moveable between a seated position and an unseated position relative to the fan duct.

15. A turbomachine support method including:
coupling a fan duct to a bearing housing with a support rod;
seating an end of a support rod within a socket of a fan duct support or a bearing housing support; and
unseating the end of the support rod from the socket while still coupling the fan duct to the bearing housing with the support rod.

16. The turbomachine support method of claim 15, unseating the end by decreasing a radial distance between the fan duct and the bearing housing.

17. The turbomachine support method of claim 15, rotating the support rod about the end during the seating.
